(19) United States
(12) Patent Application Publication
(10) Pub. No.: US 2007/0057854 A1
(43) Pub. Date: Mar. 15, 2007

(54) Mobile transceiver and antenna device

(75) Inventors: Noriaki Oodachi, Kawasaki-Shi (JP); Makoto Higaki, Yokohama-Shi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: KABUSHIKI KAISHA TOSHIBA, Minato-Ku (JP)

(21) Appl. No.: 11/500,354

(22) Filed: Aug. 8, 2006

(30) Foreign Application Priority Data
Sep. 13, 2005 (JP) 2005-265829

(51) Int. Cl. H01Q 1/24

(52) U.S. Cl. 343/702

(57) ABSTRACT

A mobile transceiver that can carry out a wireless communication includes a substrate including a wireless circuit; a built-in antenna disposed on a surface of the substrate; a first conductor disposed on the other surface of the substrate; and a second conductor having a ground side grounded to the first conductor, the second conductor being configured to improve the reduction of gain in the direction where the built-in antenna is not disposed.

### CROSS-REFERENCE TO RELATED APPLICATION

This application is based upon and claims the benefit of priority from the prior Japanese Patent Applications No. 2005-265829, filed on Sep. 13, 2005, the entire contents of which are incorporated herein by reference.

### BACKGROUND OF THE INVENTION

1. Field of the Invention

The present invention relates to a mobile transceiver such as a mobile terminal in which a mobile phone or a transceiver, for example, is embedded, and more particularly to an antenna device embedded in a mobile transceiver.

2. Related Art

In recent mobile transceivers such as a mobile phone, game equipment with a built-in transceiver, a notebook type personal computer with a built-in transceiver, and the like, it is desired to provide them with a built-in antenna that is essential to a wireless communication from a view point of prevention of breakage of the antenna when the mobile transceivers are dropped and a view point of design. In these mobile transceivers, since a communication is not carried out in a definite direction, a omnidirectional radiation pattern is necessary to realize a communication in all the directions. However, when a built-in antenna is used, a problem arises in that realization of the omnidirectional radiation pattern is difficult.

When an external monopole antenna is connected to a mobile transceiver, since an electric wave radiated from the monopole antenna is uniformly radiated in all the directions, the omnidirectional radiation pattern can be easily realized. In contrast, the built-in antenna is disposed very closely to a circuit board on which a transceiver circuit is disposed. In general, since a ground layer acting as a reference of a potential is formed on the circuit board, it is difficult for an electric wave to pass through the circuit board. Accordingly, a gain in a direction where the built-in antenna is disposed is high, whereas a gain in a direction where the built-in antenna is not disposed is low. That is, the built-in antenna is defective in that it is difficult for it to realize omnidirectionality. Thus, when a transceiver is used in an indefinite state as in the mobile transceiver, a problem arises in that the communication performance of the mobile transceiver is deteriorated because the directionality of the built-in antenna cannot properly cope with a state in which it is used. A technology disclosed in, for example, Japanese Patent Application Laid-Open Publication No. 2003-258523 (FIG. 1) is known as a technology for improving directionality.

However, since the technology disclosed in the publication pays attention to improve the radiation efficiency of an antenna by reducing a gain in a direction of a human body and increasing a gain in a direction opposite to the human body, it cannot realize omnidirectionality. As a result, the technology is defective in that it is difficult to carry out a communication in all the directions and a communication performance is not stable.

### SUMMARY OF THE INVENTION

An object of the present invention, which was made to overcome the above problem, is to provide a radiation pattern near to omnidirectionality by improving a gain of a surface opposite to a surface on which a built-in antenna is disposed. A mobile transceiver according to an embodiment of the present invention, which can carry out a wireless communication, the mobile transceiver comprises a substrate including a wireless circuit; a built-in antenna disposed on a surface of the substrate; a first conductor disposed on the other surface of the substrate; and a second conductor having a ground side grounded to the first conductor.

An antenna device according to an embodiment of the present invention comprises a substrate; a built-in antenna disposed on a surface of the substrate; a first conductor disposed on the other surface of the substrate; and a second conductor having a ground side grounded to the first conductor.

### BRIEF DESCRIPTION OF THE DRAWINGS

FIGS. 1A and 1B are views showing an arrangement of an antenna device built in a transceiver according to a first embodiment of the present invention;

FIG. 2 is a view explaining a feed point;

FIG. 3 is a view showing a structure including the case 9;

FIG. 4 is a schematic configurational view when the mobile transceiver of the present invention is viewed from right beside of the view shown in FIG. 3;

FIG. 5 is a graph showing a result of calculation for confirming an effect of the present invention;

FIG. 6 shows the length of the radiation side of the second conductor plate 5;

FIG. 7 shows the height of the second conductor plate 5;

FIG. 8 is a view showing an arrangement of an antenna device built in a transceiver according to a first modification of the first embodiment of the present invention;

FIG. 9 is a view showing an arrangement of an antenna device built in a transceiver according to a second modification of the first embodiment of the present invention;

FIG. 10 is a view showing an arrangement of an antenna device built in a transceiver according to a third modification of the first embodiment of the present invention;

FIG. 11 is a view showing an arrangement of an antenna device built in a transceiver according to a fourth modification of the first embodiment of the present invention;

FIG. 12 is a view showing an arrangement of an antenna device built in a transceiver according to a fifth modification of the first embodiment of the present invention;

FIG. 13 is a view showing an arrangement of an antenna device built in a transceiver according to a sixth modification of the first embodiment of the present invention;

FIG. 14 is a view showing an arrangement of an antenna device built in a transceiver according to a seventh modification of the first embodiment of the present invention;

FIG. 15 is a view showing an arrangement of an antenna device built in a transceiver according to a eighth modification of the first embodiment of the present invention;

FIG. 16 is a view showing an arrangement of an antenna device built in a transceiver according to a ninth modification of the first embodiment of the present invention;

FIG. 17 is a view showing an arrangement of an antenna device built in a transceiver according to a tenth modification of the first embodiment of the present invention;

FIG. 18 is a view showing an arrangement of an antenna device built in a transceiver according to a eleventh modification of the first embodiment of the present invention;

FIG. 19 is a view showing an arrangement of an antenna device built in a transceiver according to a twelfth modification of the first embodiment of the present invention;

FIG. 20 is a view showing an arrangement of an antenna device built in a transceiver according to a thirteenth modification of the first embodiment of the present invention;

FIG. 21 is a view showing an arrangement of an antenna device built in a transceiver according to a fourteenth modification of the first embodiment of the present invention;

FIG. 22 is a view showing an arrangement of an antenna device built in a transceiver according to a fifteenth modification of the first embodiment of the present invention;

FIG. 23 is a view showing an arrangement of an antenna device built in a transceiver according to a sixteenth modification of the first embodiment of the present invention;

FIG. 24 is a view showing an arrangement of an antenna device built in a transceiver according to a seventeenth modification of the first embodiment of the present invention;

FIG. 25 is a view showing an arrangement of an antenna device built in a transceiver according to a eighteenth modification of the first embodiment of the present invention;

FIG. 26 is a view showing an arrangement of an antenna device built in a transceiver according to a nineteenth modification of the first embodiment of the present invention;

FIG. 27 is a configurational view of an antenna device built in a mobile transceiver according to a second embodiment;

FIG. 28 is a configurational view of an antenna device built in a mobile transceiver according to a third embodiment;

FIG. 29 is a configurational view of an antenna device built in a mobile transceiver according to a fourth embodiment; and

FIG. 30 is a configurational view of an antenna device built in a mobile transceiver according to a fifth embodiment.

### DETAILED DESCRIPTION OF THE INVENTION

A best mode of the present invention will be described below in detail with reference to the drawings.

### First Embodiment

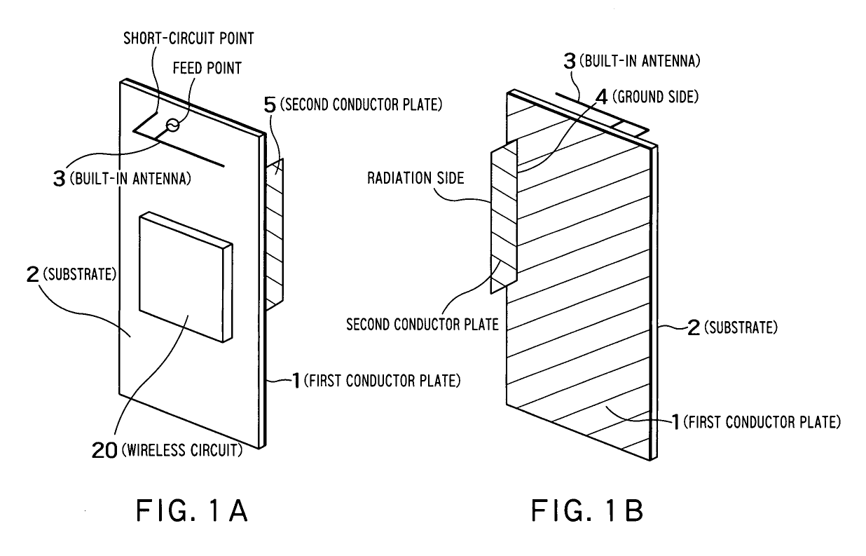

FIGS. 1A and 1B are views showing an arrangement of an antenna device built in a transceiver according to a first embodiment of the present invention. The antenna device has a feature in that it includes a substrate 2 having two surfaces, a built-in antenna 3 disposed on one of the surfaces of the substrate 2, a first conductor plate 1 disposed on the other surface of the substrate 2 on which the built-in antenna 3 is not disposed, and a second conductor plate 5 connected to the first conductor plate 1. A wireless circuit 20 is mounted on the substrate 2 to realize a wireless communication function. FIG. 1A is a perspective view when the antenna device is viewed from the direction of the substrate 2, and FIG. 1B is a perspective view when the antenna device is viewed from the first conductor plate 1 side. With the above arrangement, a gain in a direction opposite to the surface on which the built-in antenna 3 is disposed is improved, thereby a radiation pattern near to omnidirectionality can be realized. The respective components will be explained below, and then a principle by which the gain is improved will be explained.

First, the respective components will be explained. The first conductor plate 1 is a conductor layer formed on the substrate 2 built in a case. The case is composed of a dielectric material such as plastics and includes a liquid crystal display, input buttons, speaker, microphone, camera lens, signal arrival light, and the like that are necessary to a mobile transceiver (all of which are not shown). The dielectric material has a small loss and an excellent electric wave transmission characteristic when it has a small relative permittivity. Note that since the case is the same as that shown in FIG. 3, it is omitted in FIG. 1.

Components such as the wireless circuit 20, a signal processing circuit, battery, and the like that are not shown are mounted on the substrate 2. The wireless circuit 20 and the signal processing circuit have a function for carrying out a wireless communication of a mobile phone and the like. In general, the wireless circuit 20 and the signal processing circuit requires a dielectric material and a ground acting as a reference of a potential. In many cases, the ground is formed to exist on the overall substrate 2 instead of existing at only one position. The ground exists as a ground plate. In the embodiment, the first conductor plate 1 acts as the ground plate.

The shape of the first conductor plate 1 may be the same as or different from the substrate 2. Further, although FIG. 1 shows the state of the ground which is used as the first conductor plate 1 and whose surface is exposed, it may be sandwiched between dielectric materials.

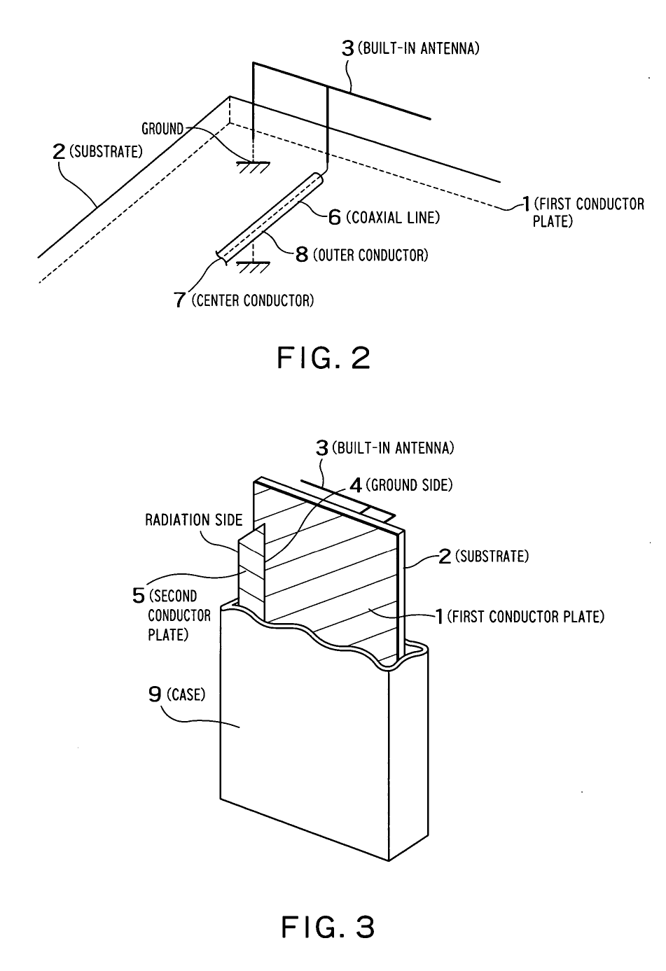

FIG. 2 is a view explaining a feed point. The built-in antenna 3 has the feed point on the one surface of the first conductor plate 1. The feed point indicates a portion where a coaxial line 6, which is connected to the not shown wireless circuit, is connected to the built-in antenna 3. Note that a center conductor 7 of the coaxial line 6 is connected to the built-in antenna 3. An external conductor 8 of the coaxial line 6 is electrically connected to the first conductor plate 1. Further, the built-in antenna 3 is built in the not shown case. Note that any other power supply structure such as a microstrip power supply line and the like may be used.

The built-in antenna 3 employs an inversed-F antenna. Since the inversed-F antenna is a low profile antenna, it is suitable to an antenna built in a small case. As shown in FIG. 2, the inversed-F antenna has a short-circuit portion. Accordingly, FIG. 1 shows the portion as a short-circuit portion and FIG. 2 shows it as grounding for realizing short-circuit. Note that an antenna other than the inversed-F antenna may be used as the built-in antenna.

The second conductor plate 5 is disposed on the surface of the substrate 2 different from the surface thereof on which the built-in antenna 3 is disposed and has a ground side 4 grounded to the first conductor plate 1. Since the first conductor plate 1 is formed in a plate shape, it has two different surfaces. Thus, the built-in antenna 3 and the second conductor plate 5 are disposed on the different surfaces, respectively. One side of the second conductor plate 5 acts as the ground side 4 grounded to the first conductor plate 1. In FIG. 1, the second conductor plate 5 is composed of a rectangular plate, and the one side thereof is acts as the ground side 4.

FIG. 3 is a view showing a structure including the case 9. Note that although the case 9 includes all the components connected to the first conductor plate 1, FIG. 3 shows the case 9 from which an upper half portion is cut off.

Next, the principle of the present invention will be explained.

In general, when the built-in antenna 3 is disposed on one surface of a conductor plate, a gain in the direction in which the built-in antenna 3 is disposed, that is, in the direction perpendicular to the surface of the first conductor plate 1 on which the built-in antenna 3 is disposed is high, and a gain in the direction in which the built-in antenna 3 is not disposed, that is, in the direction perpendicular to the surface of the first conductor plate 1 on which the built-in antenna 3 is not disposed is low. This is because although an electric wave is directly radiated from the antenna 3 in direction in which it is disposed, the effect of the electric wave directly radiated from the antenna 3 is reduced in the opposite direction by the influence of the first conductor plate 1. According, the gain is different depending on a direction, from which directionality distorted from omnidirectionality is obtained. The term “gain” used here shows the intensity of an electric wave when it is radiated and the intensity of the radiated electric wave when it is received.

However, when the built-in antenna 3 disposed to the conductor plate whose size is limited as in the present invention, radiation from a portion other than the antenna is generally taken into consideration. The radiation from the portion other than the antenna is radiation from a radio frequency current that leaks to the first conductor plate 1. It can be contemplated that an electric wave is radiated from a radio frequency current generated in an antenna, it is also radiated from a radio frequency current in the first conductor plate 1. The present invention improve the reduction of gain in the direction where the built-in antenna 3 is not disposed by controlling the distribution of the high frequency current generated by the first conductor plate 1 by means of the second conductor plate 5.

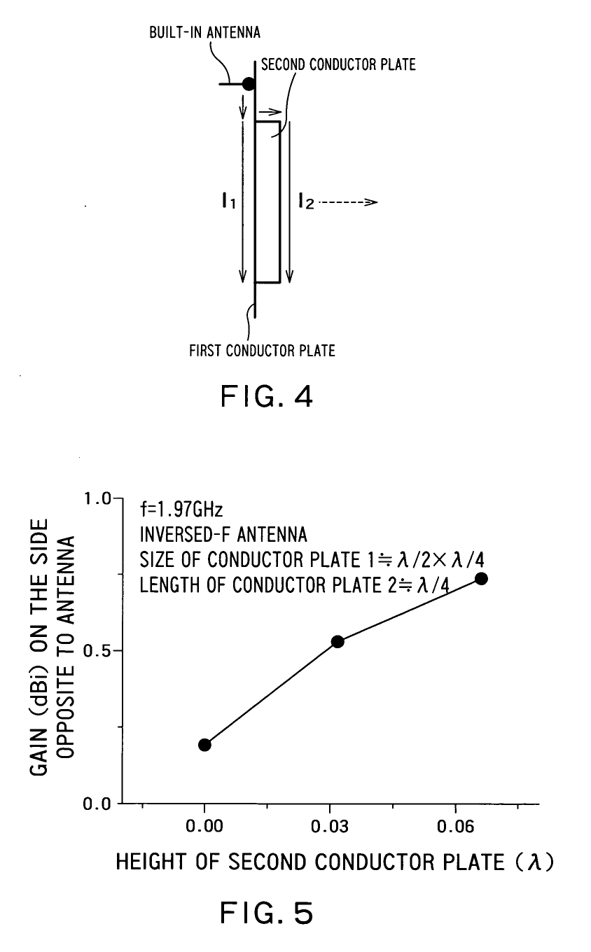

The change of distribution of the current in the second conductor plate and an improvement of gain resulting therefrom will be explained using FIG. 4. FIG. 4 is a schematic configurational view when the mobile transceiver of the present invention is viewed from right beside of the view shown in FIG. 3. If the second conductor plate 5 is not employed, a leaked high frequency current exists in the first conductor plate 1 in a distribution determined by the position of the built-in antenna 3 and the shape of the first conductor plate 1. In contrast, when the second conductor plate 5 is disposed, since it has the ground side 4 to the first conductor plate 1, a radio frequency current flows also to the second conductor plate 5. At the time, since the high frequency current has such a physical phenomenon that it is generated strongly in the edge of conductor plate, a new high frequency current I2 exists in the outer periphery of the second conductor plate 5. As a result, the leaked high frequency current is radiated from a high frequency current I1 originally distributed in the first conductor plate 1 and from the high frequency current I2 distributed in the second conductor plate 5. At the time, the high frequency current I2 in the second conductor plate 5 has a feature in that the phase thereof more advances than the high frequency current I1 in the first conductor plate 1. This phenomenon results from that since the second conductor plate 5 has a long path because it has a large height as shown in FIG. 4, thereby the phase of the current is advanced. As a result, the high frequency current I1 in the first conductor plate 1 and the high frequency current I2 in the second conductor plate 5 having the advanced phase than the phase of the high frequency current I1 may act as wave sources of radiation. Note that, in the above description, the phase of the current of the first conductor plate 1 is the phase of the current in the vicinity of the ground side 4 of the second conductor plate 5 and does not explain the overall phase of the first conductor plate 1.

When wave sources having a phase difference exist at different positions, directionality of the electric wave is changed by array antenna theory. Specifically, the radiation from the first conductor plate 1 and the radiation from the second conductor plate 5 are intensified by each other in the direction where a wave source having an advanced phase exists with respect to the first conductor plate 1 as a reference, and thus a gain in increased. From this action, when the second conductor plate 5 is provided in the present invention, the gain on the side where the second conductor plate 5 exists is made larger than a case in which the second conductor plate 5 is not provided. In this case, a radiation pattern near to omnidirectionality can be realized as a result of improvement of the gain in the low gain direction, although distorted directionality is obtained when the second conductor plate is not provided.

FIG. 5 is a graph showing a result of calculation for confirming an effect of the present invention. A mobile transceiver used to confirm the effect has such a structure that the operation center frequency of a built-in antenna 3 is set to 1.97 GHz, a first conductor plate 1 has a size of about λ/2×λ/4, the built-in antenna 3 is an inversed-F antenna, and a second conductor plate 5 has a length of about λ/4. λ shows the operation center frequency of the built-in antenna 3 and shows a wavelength corresponding to 1.97 GHz. A moment method is used for the calculation. In FIG. 5, the lateral axis shows the height of the second conductor plate 5, and the vertical axis shows the gain in a direction opposite to the direction where the built-in antenna 3 is disposed. The opposite direction shows the direction vertical to the first conductor plate 1 on the right side of the first conductor plate 1 of FIG. 4 (the direction of a dotted arrow in FIG. 4).

As apparent from FIG. 5, it can be found that the gain is improved by the provision of the second conductor plate 5. An increase of the height of the second conductor plate 5 increases the phase difference between the current of the first conductor plate 1 and current of the second conductor plate 5, thereby a gain improvement effect can be increased.

As described above in the mobile transmitter of the present invention, the gain in the direction opposite to the side where the built-in antenna 3 is disposed can be improved by disposing the second conductor plate 5 on the side opposite to the side where the built-in antenna 3 is disposed. As a result, omnidirectionality necessary to the transceiver such as the mobile transmitter whose state of use is variable can be easily realized.

Note that, in the present invention, the second conductor plate 5 has the ground side 4. When the second conductor plate 5 is not grounded, the distribution of current generated in the second conductor plate 5 is reduced and thus the effect of improvement is small. Since a physical magnitude of the second conductor plate 5 is needed to be about λ/2 to increase the distribution of current of the second conductor plate 5 without grounding it, it is difficult to build the second conductor plate in the mobile transmitter. When the second conductor plate 5 having the length of about λ/2 is used without grounding it, a current resonates in the second conductor plate 5. As a result, a problem arises in that the distribution of current of the first conductor plate 1 changes and thus the input impedance of the built-in antenna 3 is changed, by which design is made difficult. Further, a problem also arises in that it is difficult to control the distribution of current of the second conductor plate 5 that is not grounded.

In the present invention, since the grounded second conductor plate 5 is used, the gain improvement effect can be obtained even if the length thereof is smaller than λ/2. Further, the characteristic of the second conductor plate 5 can be improved under the condition that it does not resonate, the problem that the input impedance of the built-in antenna 3 changes is hardly to arise. Further, since the operation principle does not use resonance, the gain can be improved in a wide band.

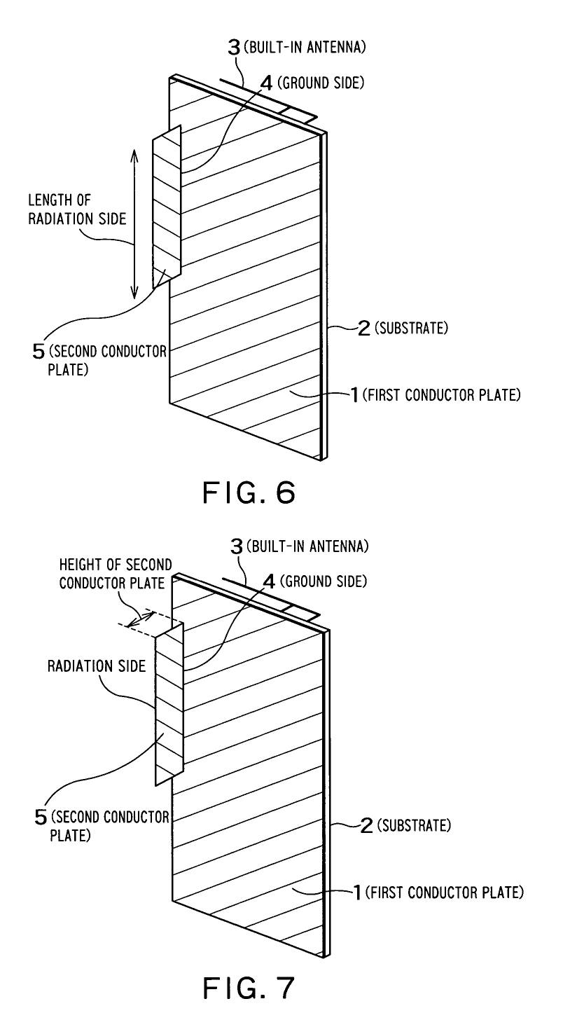

It is possible to more increase the amount of improvement of the gain by forming the second conductor plate 5 in parallel with the first conductor plate 1 as well as providing it with a side that is not grounded to the first conductor plate 1. Since the side is a portion that contributes to radiation for improving the gain, it is called a “radiation side”. As shown in FIG. 5, the gain is improved by separating the radiation side from the first conductor plate 1. Accordingly, when the height of the radiation side is unchanged, an arrangement for most separating the radiation side from the first conductor plate 1 is to arrange the radiation side in parallel with the first conductor plate 1. FIG. 6 shows the length of the radiation side.

When the length of the second conductor plate 5 is set λ/2 or less as shown in FIG. 6, the gain improvement effect can be made compatible with the reduction in size of the second conductor plate 5. Here, the length corresponds to the length of the radiation side and is equivalent to the length of the radio frequency current of the radiation wave source. Since the phase of the radio frequency current advances 180° when it is set to λ/2, when the length of the radiation side is set to λ/2 or more, portions in that the radio frequency current cancel each other are formed, and thus the gain may be deteriorated. Accordingly, not only the gain is improved but also the size of the second conductor plate can be reduced by setting the length of the radiation side to λ/2 or less.

FIG. 7 shows the height of the second conductor plate 5. The improvement of gain can be made compatible with the reduction in size of the second conductor plate 5 by setting the height of the second conductor plate 5 to λ/4 or less. When the height of the second conductor plate 5 is set to λ/4, the phase of the current of the radiation side advances about 90° with respect to the phase of the current of the first conductor plate 1. At the time, the radiations from the first conductor plate 1 and the second conductor plate 5 have an inverse phase in a direction opposite to the second conductor plate 5 with respect to the first conductor plate 1 as the reference, and thus the radiations have an effect of cancellation. Inversely, in the direction of the second conductor plate 5, the radiations are synthesized with each other in the same phase. Accordingly, when the height of the second conductor plate 5 is set to λ/4, the gain in the direction opposite to the direction where the built-in antenna 3 is disposed is improved, and omnidirectionality is realized. When the height of the second conductor plate 5 is set to λ/4 or less, the improvement of gain can be made compatible with the reduction in size of the second conductor plate 5.

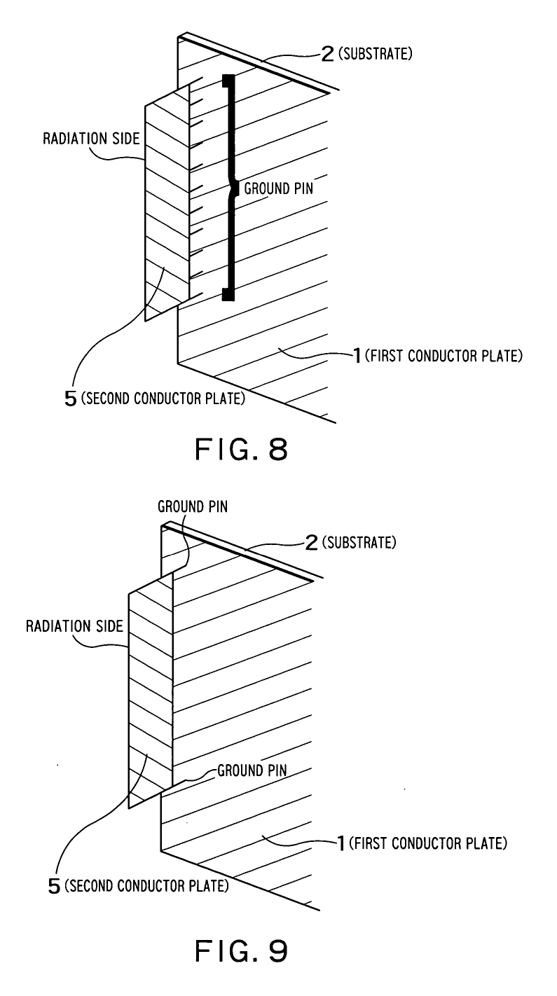

Modifications of the first embodiment will be described below using FIGS. 8 to 26.

FIG. 8 shows a first modification. As shown in FIG. 8, the ground side 4 of the second conductor plate 5 may be partly grounded to the first conductor plate 1 using ground pins at intervals of one-tenth a wavelength. With this arrangement, a case can be coped with in which it is desired to dispose a signal line of a display and a power line of a battery so as to traverse the second conductor plate 5. In this case, when the ground intervals are set to λ/10 or less, since the ground side 4 is equivalent to that it is entirely grounded from a view point of radio frequency, it is possible to dispose the second conductor plate 5 such that the other line traverses the second conductor plate 5 while obtaining an electric characteristic.

As described above, in the modification 1, since the ground side 4 of the second conductor plate 5 is partly grounded to the first conductor plate 1 at the intervals of, for example, λ/10 or less, a degree of freedom for disposing the lines can be improved while keeping the gain improvement effect.

FIG. 9 shows a second modification. As shown in FIG. 9, the ground side 4 of the second conductor plate 5 may be partly grounded to the first conductor plate 1 at only both the ends thereof using the ground pins. The other lines can be also disposed so as to traverse the second conductor plate 5 also in the second modification likewise the first modification. When the ground side 4 is grounded at only both the ends thereof, a current is distributed differently from the case in which the ground side 4 is grounded in its entirety and the case in which it is grounded at the intervals of λ/10 or less. However, since the current of the first conductor plate 1 flows from the portion where the ground side 4 is disposed to the second conductor plate 5, a distribution of a current, which returns in the direction of the first conductor plate 1 from a different portion where the ground side 4 is disposed, is formed.

Accordingly, since the phase of the current of the radiation side of the second conductor plate 5 advances as compared with the current of the first conductor plate 1 likewise the above explanation, the gain improvement effect can be obtained. Note that when the ground side 4 is grounded at only one end, the current distribution as described above is not formed. In particular, when the length of the second conductor plate 5 is set to λ/4, a resonant current having a large amplitude is generated in the second conductor plate 5, from which a problem arises in that not only directionality is disturbed but also the input impedance of the built-in antenna 3 is changed. Further, when the length of the second conductor plate 5 is less than λ/4, a current amplitude is greatly reduced, and thus the gain improvement effect is unlike to be obtained. This phenomenon is unavoidable because the current is set to zero at the extreme end of the second conductor plate 5 which is not grounded. In contrast, in the present invention, since both the ends of the second conductor plate 5 is grounded, the current is not set to zero, thereby the current amplitude is increased and the gain improvement effect can be increased by it.

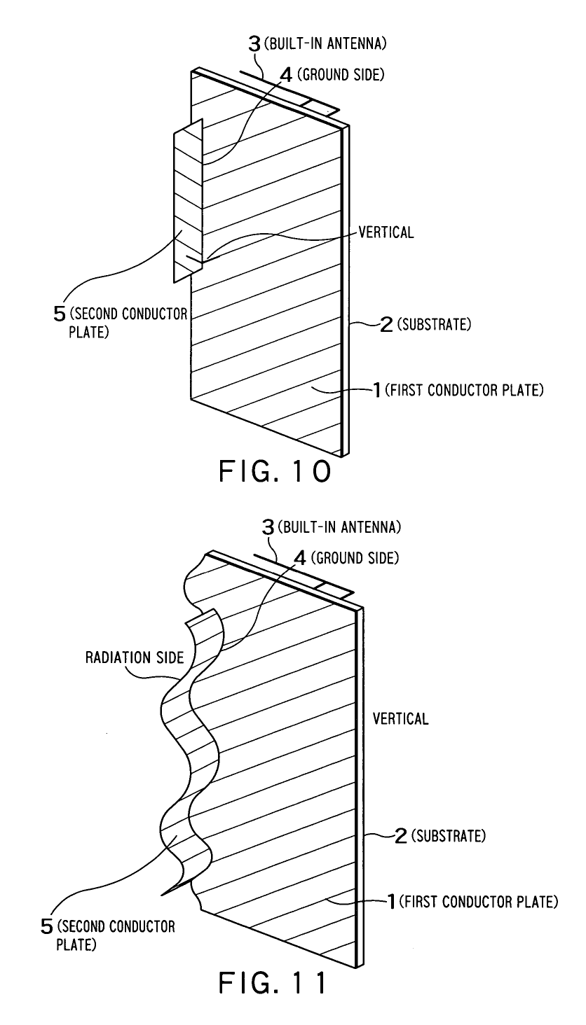

FIG. 10 shows a third modification. Since the second conductor plate 5 is connected to the first conductor plate 1 vertically as shown in FIG. 10, the gain improvement effect can be further obtained. As shown in FIG. 5, this is the same principle as that the gain improvement effect can be improved by separating the radiation side from the first conductor plate 1. As described above, in the third modification, the second conductor plate 5 can be reduced in size as well as the gain improvement effect can be also obtained.

FIG. 11 shows a fourth modification. As shown in FIG. 11, the second conductor plate 5 may be formed of a curved surface in conformity with the shape of the first conductor plate 1. When the first conductor plate 1 is formed in a shape other than a rectangular shape, the second conductor plate 5 may be formed of the curved surface so that it can be reduced in size.

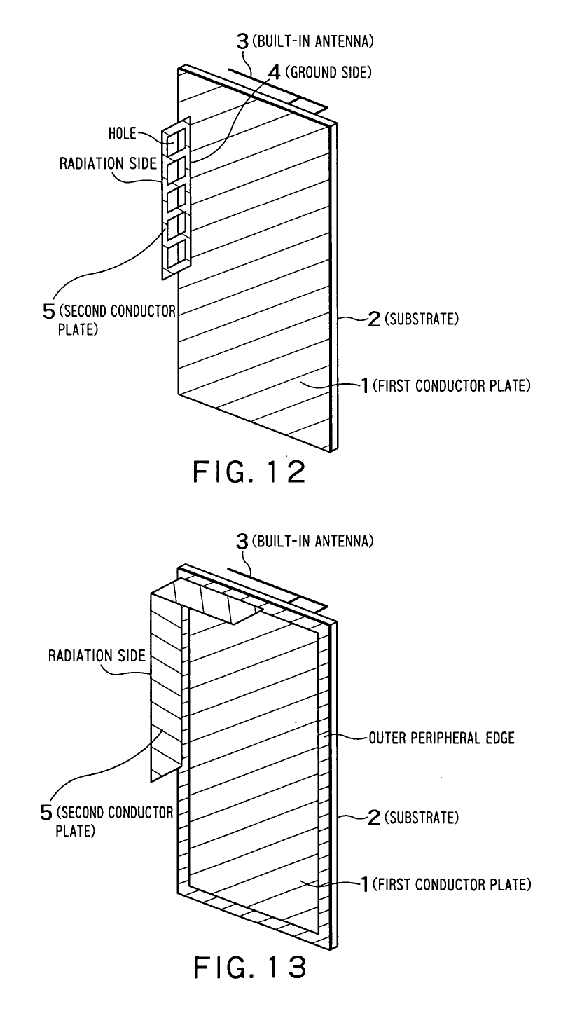

FIG. 12 shows a fifth modification. As shown in FIG. 12, the second conductor plate 5 may have a structure with a plurality of holes. In this case, the second conductor plate 5 can be reduced in weight, and a wiring may traverse it. Since a radio frequency current tends to strongly appear at the edges of the second conductor plate 5, even if holes are formed at the center of the second conductor plate 5 as shown in FIG. 12, it is not almost influenced by them from a view point of a radio frequency. Accordingly, the second conductor plate 5 has the same electric performance as the case without holes, thereby the gain improvement effect can be obtained.

FIG. 13 shows a sixth modification. As shown in FIG. 13, the gain improvement effect can be obtained by disposing the second conductor plate 5 along the outer peripheral edges of the first conductor plate 1. In general, a leakage radio frequency current to a conductor plate has a feature in that it is strongly generated in the edges of the conductor plate. That is, an electric wave is greatly radiated from the edges of the conductor plate. When the second conductor plate 5 is disposed along the outer peripheral edges of the first conductor plate 1, a radio frequency current with a large amplitude is generated in the second conductor plate 5. As a result, the electric wave radiated from the radiation side of the second conductor plate 5 is increased, from which an effect can be obtained in that the amount of improvement of the gain is increased in the direction opposite to the side where the built-in antenna 3 is disposed. Further, the ground side 4 may be disposed along the outer peripheral edge of the first conductor plate 1 in a bent state in place of a linear state.

Further, when the second conductor plate 5 is disposed such that it has the same polarized wave as that of the built-in antenna 3, the polarized wave can be synthesized to improve the gain. Since the electric wave radiated from second conductor plate 5 is mainly radiated from the radiation side of the second conductor plate 5 acting as the wave source, the direction of the radiation side of the second conductor plate 5 corresponds to the direction of the polarized wave. Since the case shown in, for example, FIG. 1 has the radiation side disposed in a longitudinal direction, the polarized wave is made to a longitudinal linear polarized wave. Further, since the case shown in FIG. 13 has radiation sides of both the longitudinal and lateral directions, the polarized waves are synthesized into an obliquely linear polarized wave.

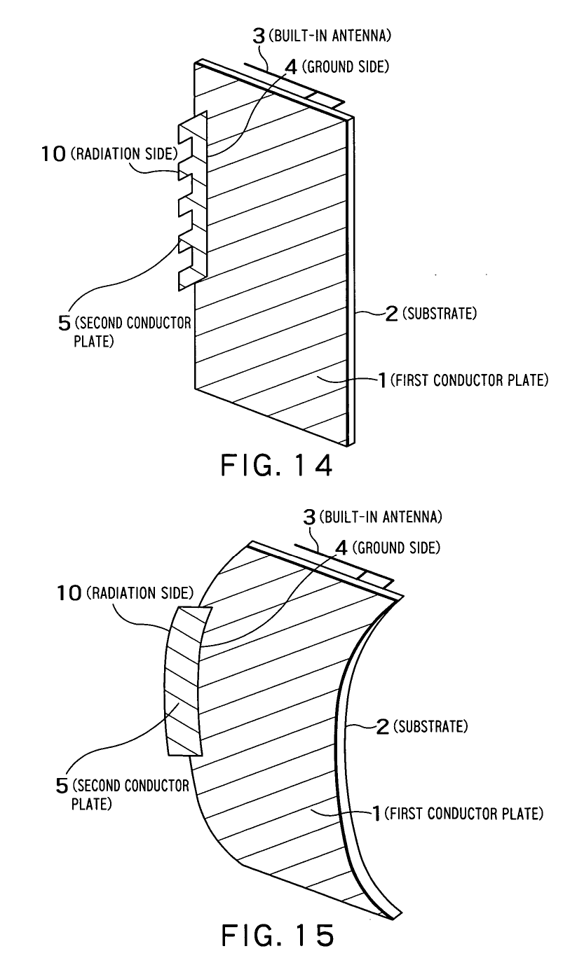

FIG. 14 shows a seventh modification. As shown in 14, it is possible to adjust the phase of the radio frequency current of a radiation side 10 of the second conductor plate 5 by forming the radiation side 10 in a saw-tooth shape, thereby the phase of a radiated electric wave can be controlled. When the radiation side 10 has the saw-tooth shaped concave and convex portions, a path on the radiation side 10 looks long. When it is assumed that a current flows strongly along the edges of a conductor, a longer path of the radiation side more advances the phase of a current. That is, the saw-tooth shaped radiation side has a current wave source with an advanced phase as compared with a flat radiation side, thereby the saw-tooth shaped radiation side radiates an electric wave with an advanced phase. Radiated electric waves with a phase difference are effective to form a circular polarized wave. Since it is contemplated that the circular polarized wave is synthesized from two linear polarized waves with a phase difference of 90°, the radiation side formed in the saw-tooth shape to radiate the polarized wave is effective to control the phase thereof.

FIG. 15 shows an eighth modification. As shown in FIG. 15, when the first conductor plate 1 is formed of a curved surface in placed of a flat surface, the second conductor plate 5 may be disposed along the curved surface.

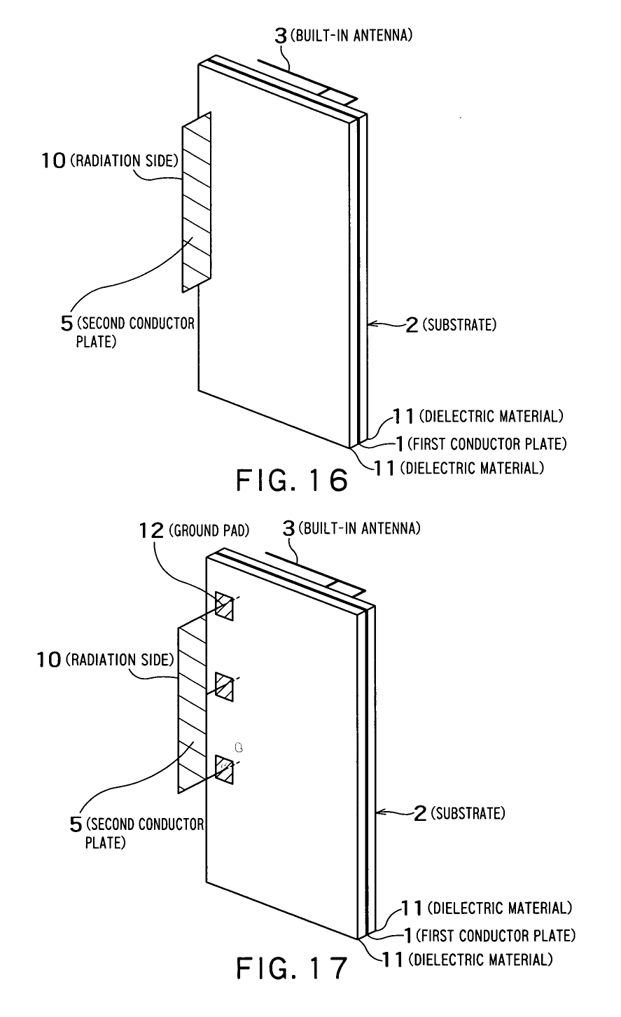

FIG. 16 shows a ninth modification. As shown in FIG. 16, dielectric materials 11 may be formed such that the first conductor plate 1 is sandwiched therebetween. This arrangement is advantageous in that both the surfaces of the dielectric materials 11 can be used to form circuit wirings thereon.

FIG. 17 shows a tenth modification. When the surface of the first conductor plate 1 is not exposed to the side thereof where the second conductor plate 5 is disposed, the second conductor plate 5 can be grounded by disposing ground pads 12, which are grounded to the first conductor plate 1, on the dielectric substrate 2 as shown in FIG. 17. Note that the ground pads 12 are grounded by pins passing through the first conductor plate 1 and the dielectric materials 11.

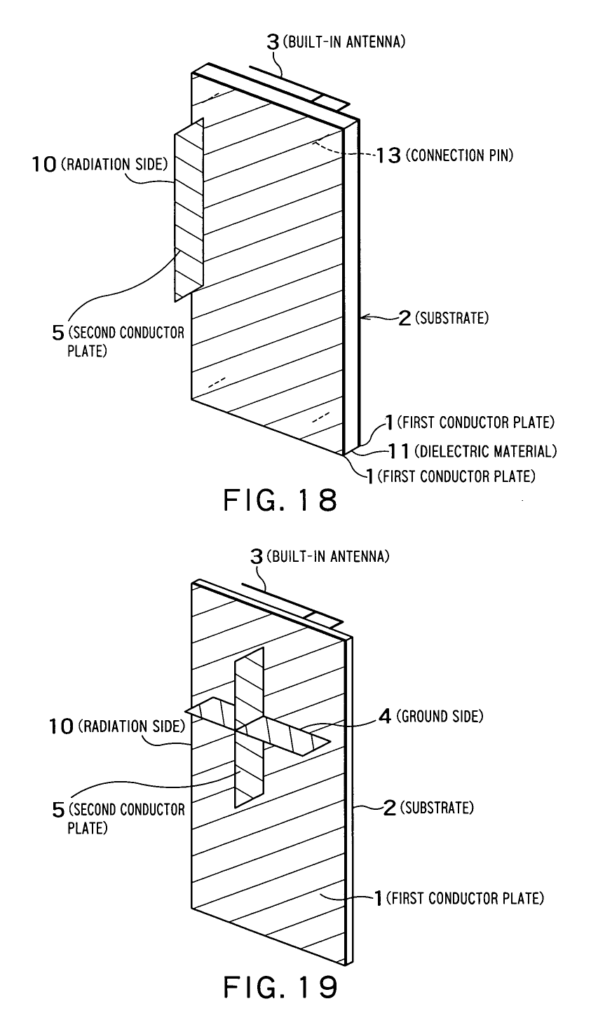

FIG. 18 shows an eleventh modification. As shown in FIG. 18, when the substrate 2 has a plurality of grounds, they are connected by connection pins 13.

FIG. 19 shows a twelfth modification. As shown in FIG. 19, the second conductor plate 5 may be composed of a combination of a plurality of flat surfaces in place of a flat surface. In the modification shown in FIG. 19, a plurality of the second conductor plates 5 are disposed in a crisscross shape. In this case, the radiation side is not formed only of a linear line, thereby the gain of the polarized wave can be improved in correspondence to the shape of the radiation side. In the modification, the gains of both vertical and horizontal polarized waves can be improved.

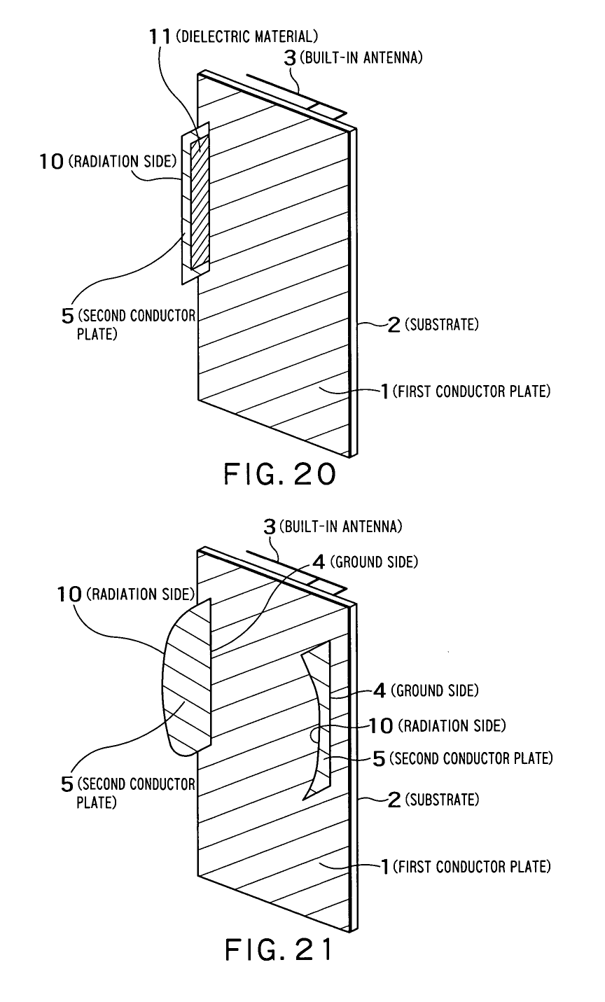

FIG. 20 shows a thirteenth modification. As shown in FIG. 20, only the outer peripheral portion of the second conductor plate 5 is left by removing the portion thereof other than the outer peripheral portion, and the removed portion is filled with the dielectric material 11. The gain improvement effect can be also obtained even in this arrangement because the main radiating portion of the outer peripheral portion of the second conductor plate 5 is not changed. Further, an effect of increasing a mechanical strength can be also obtained by connecting the dielectric material 11 to the first conductor plate 1.

FIG. 21 is a view showing a fourteenth modification. As shown in FIG. 21, the radiation side 10 of the second conductor plate 5 may be formed in a curved shape in place of forming it in parallel with the ground side 4 of the first conductor plate 1. This is effective when the second conductor plate 5 is designed in conformity with the shape of the case.

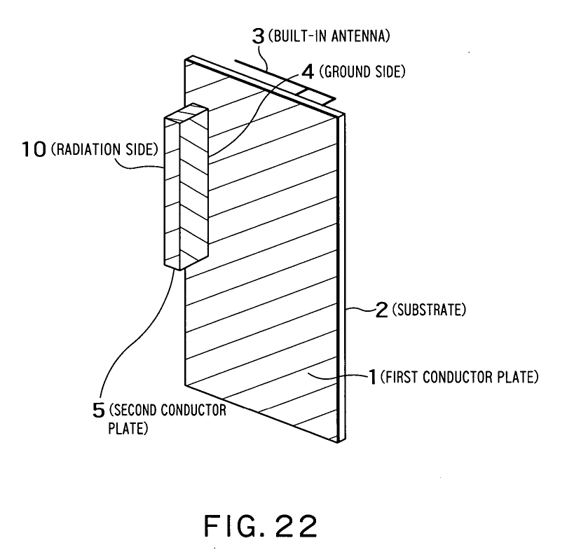

FIG. 22 is a view showing a fifteenth modification. As shown in FIG. 22, the second conductor plate 5 can be provided with a thickness. When the radiation side 10 has a thickness, the gain improvement effect can be obtained likewise the explanation up to now. With this arrangement, an effect of using the second conductor plate 5 also as a support member for increasing the strength of the case can be obtained.

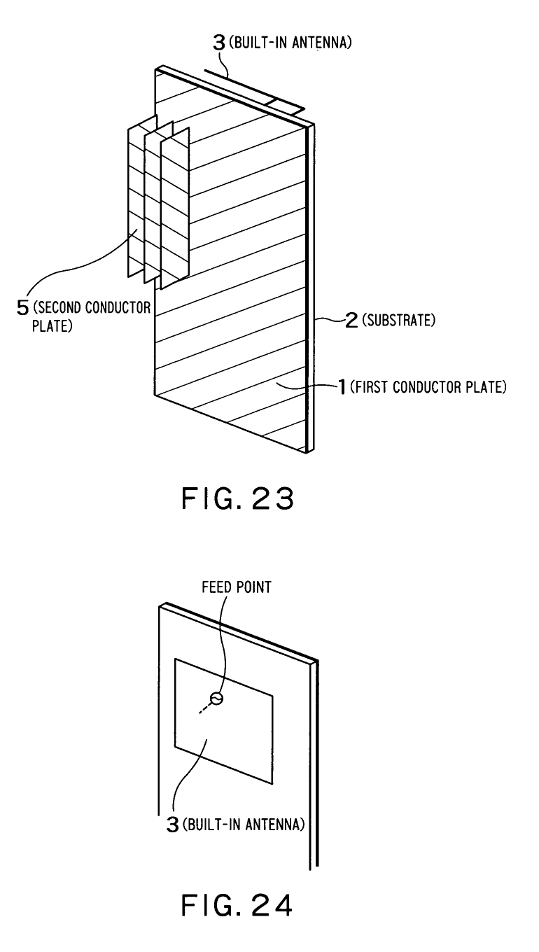

FIG. 23 is a view showing a sixteen modification. As shown in FIG. 23, a plurality of the second conductor plates 5 are disposed very near to each other. The gain improvement effect can be enhanced by disposing the plurality of the second conductor plates 5.

FIG. 24 is a view showing a seventeenth modification. As shown in FIG. 24, the built-in antenna 3 can be realized using a patch antenna. Since the patch antenna has a low profile, a small mobile transceiver can be realized.

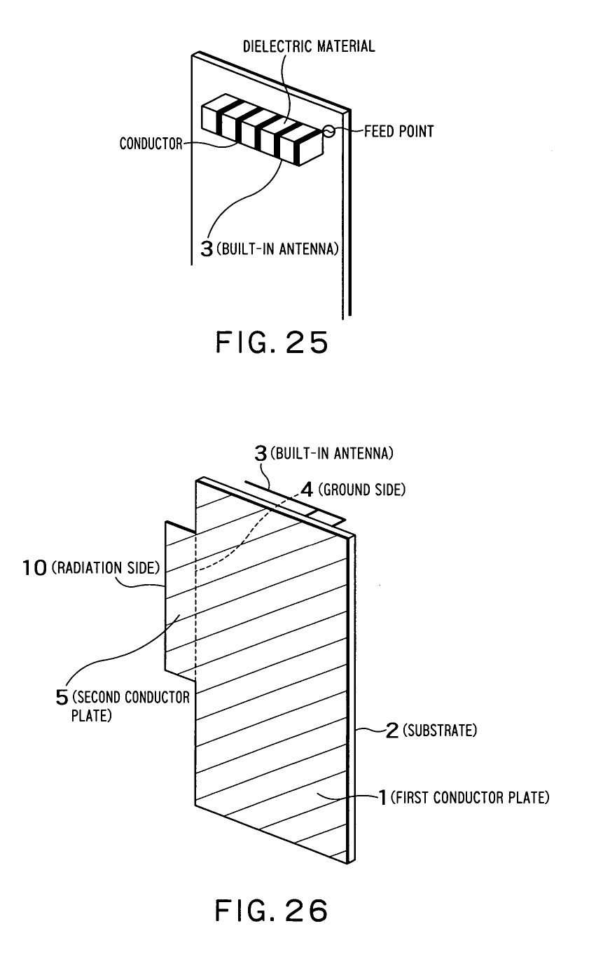

FIG. 25 shows an eighteenth modification. As shown in FIG. 25, the built-in antenna 3 can be realized using a dielectric chip antenna. The dielectric chip antenna is composed of a rectangular columnar dielectric rod around which a conductor is formed spirally. It can be said that this is a type of a helical antenna. Since the antenna is also small in size, it is effective to realize a small mobile transceiver. Note that the antenna is not limited to the types described above and any built-in antenna may be used.

FIG. 26 is a view showing a nineteenth modification. As shown in FIG. 26, the first and second conductor plates 1, 5 may be formed of the same conductor plate, and the conductor plate may be bent along the ground side 4.

### Second Embodiment

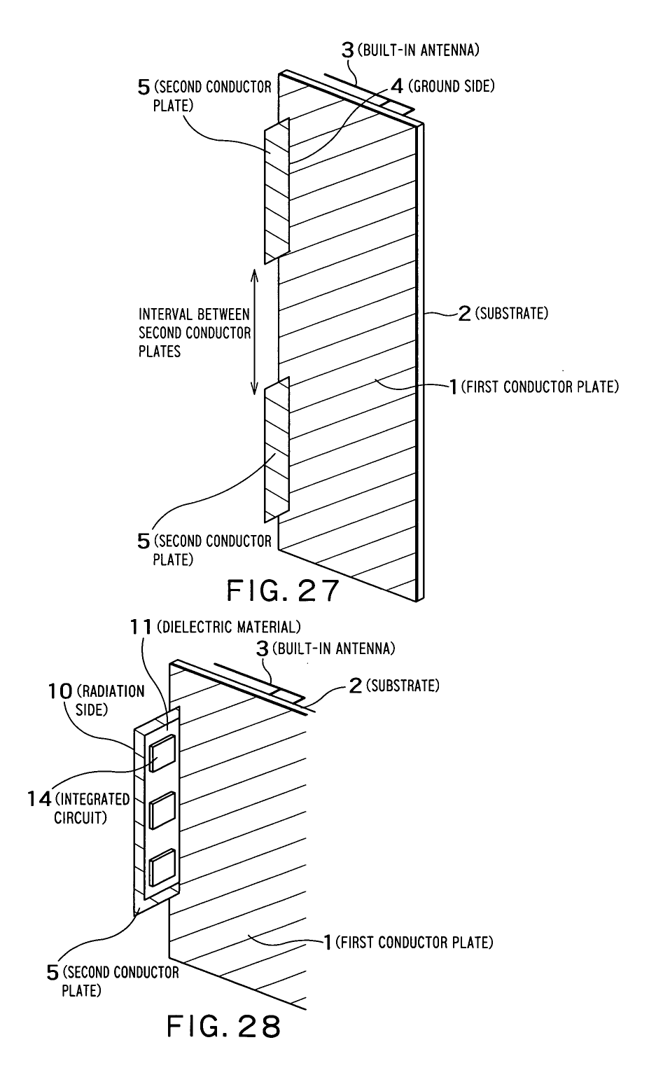

FIG. 27 is a configurational view of an antenna device built in a mobile transceiver according to a second embodiment. The embodiment includes a substrate 2 having a first conductor plate 1, a built-in antenna 3 disposed on one surface of the first conductor plate 1 and having a feed point on the surface, and a plurality of second conductor plates 5 disposed on the other surface of the first conductor plate 1, which is different from the one surface on which the built-in antenna 3 is disposed, and having ground sides 4 grounded to the first conductor plate 1. The second conductor plates 5 are disposed at intervals of λ/2. With this arrangement, a gain in a direction opposite to the surface, on which the built-in antenna 3 is disposed, is improved, thereby a radiation pattern near to omnidirectionality can be realized. Since the same components as those of the first embodiment are employed in the second embodiment, explanation thereof is omitted.

The embodiment has a feature in that the plurality of second conductor plates 5 are disposed at the intervals of λ/2. With this disposition, the phases of the radio frequency currents of the radiation sides of the second conductor plates 5 can be made to the same phase, which results in that a gain improvement effect can be enhanced.

Since the phase of a radio frequency current changes 360° in one wavelength, it changes 180° in λ/2. Accordingly, the currents having the same phase flow in the two conductor plates separated from each other at the intervals of λ/2. Since the electric waves radiated from the currents having the same phase are synthesized in the same phase, the gain improvement effect can be enhanced.

As described above, in the second embodiment, since the plurality of second conductor plate 5 are disposed at the intervals of λ/2, radiation fields from the plurality of second conductor plates 5 can be provided with the same phase, from which an effect of enhancing the gain improvement effect can be obtained. Note that although FIG. 27 shows the case in which the two second conductor plates 5 are used, a case in which three or more second conductor plates 5 are used can be embodied likewise.

### Third Embodiment

FIG. 28 is a configurational view of an antenna device built in a mobile transceiver according to a third embodiment. The antenna device is composed of a substrate 2 having a first conductor plate 1, a built-in antenna 3 disposed on one surface of the first conductor plate 1 and having a feed point on the surface, and a second conductor plate 5 disposed on the other surface of the first conductor plate 1, which is different from the one surface on which the built-in antenna 3 is disposed, and grounded to the first conductor plate 1 at a plurality of positions. The antenna device has a feature in that the portion thereof other than the outer peripheral portion of the second conductor plate 5 is composed of a dielectric material, and an integrated circuit 14 is mounted on the dielectric material.

The portion of the second conductor plate 5 other than the outer peripheral portion less contributes to radiation. Thus, in the embodiment, the portion of the second conductor plate 5 other than the outer peripheral portion is composed of the dielectric material, and integrated circuits 14 are mounted on the dielectric material. The integrated circuit 14 may be any arbitrary integrated circuit such as a digital signal processing circuit, a wireless circuit, and the like or may be a simple circuit element such as a resistor, an inductor, and the like.

The space in the mobile transceiver can be effectively used by mounting the circuit element in the portion composed of the dielectric material of the second conductor plate 5, thereby a smaller mobile transceiver can be provided. Further, the embodiment also has an effect of maintaining the gain improvement effect. In the third embodiment, it is possible to mount the integrated circuit to the portion of the second conductor plate 5, thereby the mobile transceiver can be reduced in size in its entirety by reducing an originally required circuit space.

### Fourth Embodiment

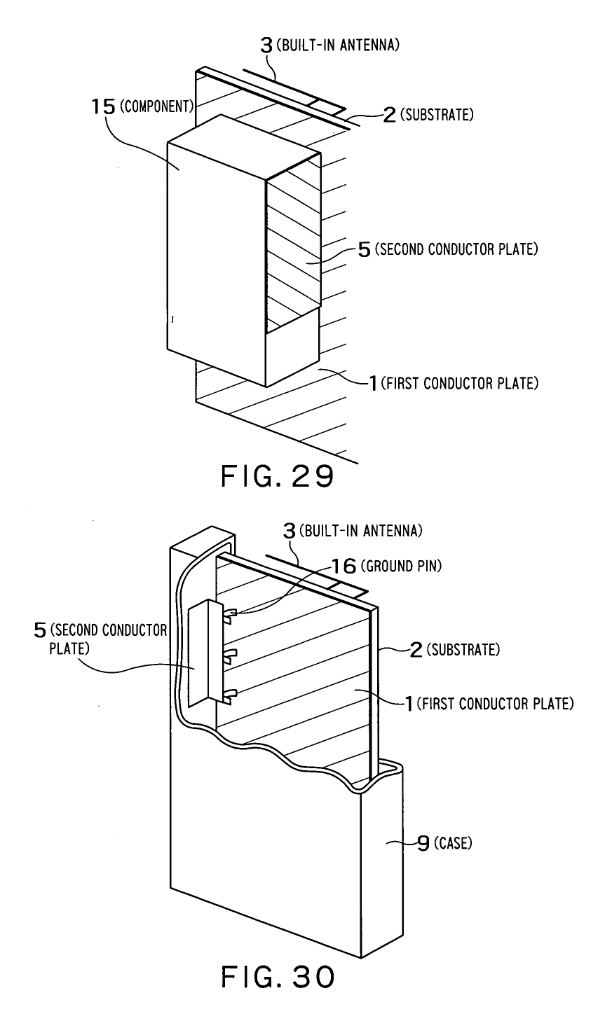

FIG. 29 is a configurational view of an antenna device built in a mobile transceiver according to a fourth embodiment. As shown in FIG. 29, the embodiment is composed of a substrate 2 having a first conductor plate 1, a built-in antenna 3 disposed on one surface of the first conductor plate 1 and having a feed point on the surface, and a second conductor plate 5 disposed on the other surface of the first conductor plate 1, which is different from the one surface on which the built-in antenna 3 is disposed, and connected to the first conductor plate 1 at a plurality of positions. Then, the second conductor plate 5 has a feature in that it is integrated with a component 15 of the mobile transceiver disposed in the vicinity thereof.

The second conductor plate 5 requires a support member because it is connected to the first conductor plate 1 in a vertical direction. However, this is contrary to the reduction in size and weight of the mobile transceiver. To cope with this problem, in the fourth embodiment, the second conductor plate 5 is integrated with the component 15 disposed in the vicinity thereof. The component 15 may be any arbitrary component such as a battery, liquid crystal device, microphone, speaker, memory, input button, and the like. Integrating the second conductor plate 5 with the component eliminates the provision of the support member of the second conductor plate 5. Further, when they are integrally manufactured in a manufacturing step, the number of parts is reduced and the cost of the mobile transceiver can be reduced thereby.

As described above in the fourth embodiment, since the support member is not necessary by integrating the second conductor plate 5 with the component of the mobile transceiver disposed in the vicinity thereof, an arrangement can be simplified and a cost can be reduced.

### Fifth Embodiment

FIG. 30 is a configurational view of an antenna device built in a mobile transceiver according to a fifth embodiment. The embodiment is composed of a substrate 2 having a first conductor plate 1, a built-in antenna 3 disposed on one surface of the first conductor plate 1 and having a feed point, and a second conductor plate 5 disposed on the other surface of the first conductor plate 1, which is different from the one surface on which the built-in antenna 3 is disposed, and grounded to the first conductor plate 1 at a plurality of positions. The first conductor plate 1 has ground pins 16 disposed thereto, and the second conductor plate 5 is integrated with a case 9.

An end of each of the ground pins 16 of the first conductor plate 1 is connected to the first conductor plate 1 by being grounded thereto. The ground pins 16 may be formed in any arbitrary shape. However, the plurality of ground pins 16 are formed to have the same height so that they can be sufficiently connected to the second conductor plate 5.

The second conductor plate 5 is bent in the vicinity of a ground side 4. The second conductor plate 5 including a radiation side is connected to a case. Although the bent portion may be formed in any arbitrary size, it is connected sufficiently to the case when it is formed as large as the ground pins 16.

When the mobile transceiver is assembled by arranging the ground pins 16 of the first conductor plate 1 and the second conductor plate 5 as described above, the bent portion of the second conductor plate 5 automatically comes into contact with the ground pins 16. Accordingly, a manufacturing step of connecting the second conductor plate 5 to the first conductor plate 1 can be omitted. Further, since an electric connection can be realized by the contact, the connection can be realized even if a contact portion is slightly dislocated. As a result, even a large amount of error occurred in a manufacture step can be neglected. Accordingly, since it is not required to manufacture the antenna device with a pinpoint accuracy, a yield can be improved and a cost can be reduced.

As described above, in the fifth embodiment, since the ground pins 16 are disposed to the first conductor plate 1 and the second conductor plate 5 is integrated with the case, the second conductor plate 5 is grounded to the first conductor plate 1 in contact therewith. As a result, there can be provided the mobile transceiver that can reduce the number of manufacturing steps, improve the yield, and reduce the cost.

The embodiments of the present invention are explained as described above. The range of application of the present invention can be widened to a radar device, in addition to the mobile terminal. In this case, the radar device can receive an electric signal omnidirectionality, which makes it possible to increase the range of an angle to which the radar device can be applied. Further, the present invention can be also applied to an adaptive array antenna. In this case, an electric wave can be received in a wide angle range, which makes it possible to receive a desired electric wave and to improve an interference potential removing ability.

Further, since the present invention can intensify a near-located electromagnetic field (near-field electromagnetic wave) likewise a far-located (far-field) gain, it can be also applied to a case in which a communication is carried out in a very near state as in a wireless tag.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A mobile transceiver that can carry out a wireless communication comprising:
a substrate including a wireless circuit;
a built-in antenna disposed on a surface of the substrate;
a first conductor disposed on the other surface of the substrate; and
a second conductor having a ground side grounded to the first conductor, the second conductor being configured to improve the reduction of gain in the direction where the built-in antenna is not disposed.

2. The mobile transceiver according to claim 1, wherein
the second conductor has a radiation side which is on the other side of the first conductor and which is disposed apart from the first conductor.

3. The mobile transceiver according to claim 1, wherein
the length of the radiation side of the second conductor is one-half or less of the wavelength of an operation center frequency of the built-in antenna.

4. The mobile transceiver according to claim 1, wherein
a plurality of the second conductors are disposed at intervals corresponding to one-half the wavelength of the operation center frequency of the built-in antenna.

5. The mobile transceiver according to claim 1, wherein
the height of the radiation side of the second conductor from the first conductor is one-fourth or less of the wavelength of the operation center frequency of the built-in antenna.

6. The mobile transceiver according to claim 1, wherein
the ground side of the second conductor is partially grounded to the first conductor at intervals one-tenth or less of the wavelength of the operation center frequency of the built-in antenna.

7. The mobile transceiver according to claim 1, wherein
the ground side of the second conductor is grounded to the first conductor at only both the corners of the ground side.

8. The mobile transceiver according to claim 1, wherein
the second conductor is connected to the first conductor vertically.

9. The mobile transceiver according to claim 1, wherein
the second conductor is formed of a curved surface along with the shape of the first conductor.

10. The mobile transceiver according to claim 1, wherein
the second conductor includes a hole between the radiation side and the ground side.

11. The mobile transceiver according to claim 1, wherein
the second conductor is disposed along the outer peripheral edges of the first conductor.

12. The mobile transceiver according to claim 1, wherein
the second conductor is disposed such that it resonates with the same polarized wave as the polarized wave with which the built-in antenna resonates.

13. The mobile transceiver according to claim 1, wherein
the radiation side of the second conductor is formed in a saw-tooth shape.

14. The mobile transceiver according to claim 1 further comprising:
a dielectric material provided to pinch the first conductor; and
a ground pad connected to the first conductor, wherein
the second conductor is connected to the first conductor through the ground pad.

15. The mobile transceiver according to claim 1, wherein
the second conductor is formed a crisscross shape.

16. The mobile transceiver according to claim 1, wherein
the second conductor is a patch antenna.

17. The mobile transceiver according to claim 1,
wherein a portion of the second conductor other than the outer peripheral portion thereof is composed of a dielectric material, and integrated circuits are mounted on the dielectric material.

18. The mobile transceiver according to claim 1, wherein
the second conductor is mounted on the first conductor as well as integrated with a component of the mobile transceiver located in the vicinity of the second conductor.

19. The mobile transceiver according to claim 1 further comprising:
connection pins disposed to the first conductor, wherein
the second conductor is integrated with a case, and the second conductor is grounded by coming into contact with the connection pins.

20. An antenna device comprising:
a substrate;
a built-in antenna disposed on a surface of the substrate;
a first conductor disposed on the other surface of the substrate; and
a second conductor having a ground side grounded to the first conductor.
